(19) United States
(12) Patent Application Publication
(10) Pub. No.: US 2009/0191308 A1
(43) Pub. Date: Jul. 30, 2009

(54) Method of preparing emulsified cereal bran derivatives

(76) Inventors: Leo G. Gingras, Scottsdale, AZ (US); Paul R. Mathewson, Scottsdale, AZ (US)

Correspondence Address: MCDERMOTT, WILL & EMERY LLP;Attn: IP Department, 227 WEST MONROE STREET, SUITE 4400, CHICAGO, IL, 60606-5096, US

(21) Appl. No.: 12/322,044

(22) Filed: Jan. 28, 2009

Related U.S. Application Data
(60) Provisional application No. 61/024,120, filed on Jan. 28, 2008.

(51) Int. Cl. A23L 1/105; A23L 1/29

(52) U.S. Cl. 426/31; 426/590; 426/618; 426/496

(57) ABSTRACT

The present invention provides a method for preparing emulsified bran derivatives and emulsified bran fractions which can be used in the preparation of nutritionally-enriched food and beverage products.

### CROSS-REFERENCE TO RELATED APPLICATIONS

This application claims priority to U.S. Provisional Application No. 61/024,120, filed Jan. 28, 2008, which is hereby incorporated by reference.

### FEDERALLY SPONSORED RESEARCH OR DEVELOPMENT

Not Applicable.

### TECHNICAL FIELD

This invention relates to a method of preparing emulsified bran derivative and emulsified bran fractions, and more particularly, a method for preparing an emulsified rice bran derivative and emulsified rice bran fractions for use in preparing a nutritionally-enriched food and beverage products.

### BACKGROUND OF THE INVENTION

Bran is a nutrient dense composition derived from the milling of cereal grains. The bran is a rich source of protein, fat, carbohydrate and a number of micronutrients such as vitamins, minerals, anti-oxidants and phytosterols. To be useful as a food ingredient, bran must be stabilized. That is, the lipid hydrolyzing and oxidizing enzymes present in the bran must be inactivated in order to prevent interaction of those enzymes, lipase and peroxidase in particular, with the oil fraction. If these enzymes are not inactivated, hydrolytic and oxidative rancidity will proceed, causing the formation of objectionable odors and flavors commonly associated with rancidity. Once stabilized however, bran serves as a dietary nutrient useful in a variety of food and beverage formulations.

The applicability of cereal or oil seed bran to food formulations can be extended by fractionating the bran into soluble and insoluble bran fractions. The separation of these fractions concentrates certain components in each fraction. These fractions derived from the processing of the bran material can be dried to a powder form. Enriched fractions provide enhanced functionality when used in certain food ingredient applications.

One application of the soluble bran fraction is in beverages based on water, milk, fruit juice and the like. Whether in manufacturing or consumer use, the powdered soluble bran fraction may be easily dissolved when added to a suitable aqueous medium. Depending on the liquid, its temperature, density and polarity, the powdered soluble bran fraction disperses with more or less speed and efficacy. It would be preferable to affect the dispersibility of the powdered soluble bran fraction in such a way that it is easily and quickly dispersed regardless of the particular characteristics of the liquid meant to receive the powdered soluble bran fraction.

The present invention provides a method for preparing a nutritious beverage containing the soluble bran fraction. It has been surprisingly found that increasing dispersibility of powdered soluble bran fractions and powdered soluble rice bran fraction in particular, can be achieved through application of an emulsifier. Specifically, the functionality of the powdered soluble bran fraction can be enhanced through the addition of a food grade emulsifier. The emulsifier increases the dispersibility of the powderd soluble bran fraction in the preparation of beverages. The increased dispersibility of the emulsified soluble bran fraction expands the formulation applications of this fraction while retaining its nutritional benefits. In addition, it has also been found that the emulsified bran derivative, obtained by emulsification of bran material accompanied by an enzyme treatment but without any fractionation steps, is equally useful as a source of enhanced nutrients in the preparation of food products including, but not limited, to beverages.

Another application of the emulsified bran derivative and emulsified soluble bran fraction of the present invention relates to its use as a processing aid in the extrusion of workable dough to produce a variety of food products including, but not limited to, snacks, cereals, pastas, and pet food.

### SUMMARY OF THE INVENTION

The present invention provides a process for preparing emulsified bran derivative comprising the steps of combining bran material and an emulsifier in an aqueous environment to prepare a slurry, digesting the resulting slurry with one or more enzymes and drying the resulting product to produce a powdered emulsified bran derivative.

In another embodiment, the present invention provides a process for preparing emulsified bran fractions comprising the steps of combining bran material and an emulsifier in an aqueous environment to prepare a slurry, digesting the resulting slurry with one or more enzymes, separating the enzyme-treated slurry into soluble and an insoluble bran fractions, and drying the soluble and the insoluble bran fractions separately to produce two different powdered emulsified nutritionally enhanced bran fractions.

In one embodiment, the present invention uses stabilized bran, preferably from rice, as the starting material for the production of an emulsified bran derivative and nutritionally enriched emulsified bran fractions. In another embodiment, the present invention uses defatted bran, preferably from rice, as the starting material for the production of an emulsified bran derivative and nutritionally enriched emulsified bran fractions.

In one embodiment of the present invention, the powdered emulsified bran derivative, the powdered emulsified soluble bran fraction and the powdered emulsified insoluble bran fraction are used individually or in combination in the preparation of a food product.

In yet another aspect of the present invention, the powdered emulsified bran derivative, the powdered emulsified soluble bran fraction and the powdered emulsified insoluble bran fraction are constituted individually or in combination with a suitable aqueous solution to produce a beverage.

Another embodiment of the present invention provides a method of improving the machinability of a workable dough comprising the steps of adding an emulsified bran derivative or an emulsified soluble bran fraction as a processing aid to a dough mix that is extruded to produce food products including, but not limited, to snacks, cereals, pastas, and pet food.

### DETAILED DESCRIPTION

The present invention relates to a process for preparing an emulsified bran derivative and emulsified bran fractions. The emulsified bran derivative and emulsified bran fractions are obtained after enzymatic digestion of bran material in the presence of at least one emulsifier. Suitable starting materials for use in the present invention may be derived from a variety of cereal grains including rice, wheat, oat, corn, rye, barley, sorghum, triticale, millet, buckweed, fonio, quinoa, teff, and kaniwa. Bran materials suitable for use in the present invention may also be derived from the oil seeds such as sunflower, safflower, sesame, mustard, rapeseed, peanut, flax seed, soybean and the like. Preferably, the bran material is derived from rice.

Anatomically, cereal grains include three major portions namely, the endosperm, the germ, and the bran. The major portion of a cereal grain is made up of starchy endosperm. For example, in the case of wheat kernel, the endosperm accounts for about 75% weight percent while the bran/germ portion makes up approximately 25% weight percent of the grain. The term “bran” generally refers to the thin layer surrounding the endosperm in a cereal grain. In general the bran fraction removed in the cereal milling operation contains some or all of the germ fraction of the cereal grain. As used in this invention, the terms “bran” or “bran fraction” includes some or all of the germ fraction. This mixed bran and germ fraction is also referred to as “bran/germ” fraction. Modern cereal milling methods have the capacity to substantially remove the germ and bran portions from the endosperm portion. The separated bran and germ portions are typical by-products of the milling operation.

Current milling process separates the bran and germ fractions in substantial quantity from the rest of the endosperm. The endosperm, the hull and the bran layer represent approximately 70%, 20%, and 10% respectively, of the rough rice. About 60 million metric tons of rice bran are generated from rice milling operation worldwide. However, this enormous amount of rice bran is not currently used in significant amounts because of its susceptibility to rancidity. Rice bran is a nutrient dense material derived from the milling of brown rice. The bran contains an array of nutritious components including protein, carbohydrate, oils and a significant quantity of micronutrients including vitamins, minerals and phytosterols that contribute positively to the metabolic processes of many organisms. These components are present naturally in the rice bran and are highly bioavailable.

In wheat milling, two different streams of products namely, the flour stream and bran/germ steam, are produced. The bran/germ portions may be separated into sub-categories generally referred to as “midds,” “shorts,” “germ,” “red dog′” and “bran.” Sometimes, the bran stream is sub-categorized as fine and coarse bran fractions.

In corn milling, the bran is derived from pericarp located beneath the water impermeable cuticle. Because of its high fiber content, the pericarp is tough. In the corn milling operation, the corn is tempered by the addition of water and passed through a corn degerminator, which frees the bran and germ and breaks the endosperm into two or more pieces. The stock from degerminator is dried and passed through a separator and through a centrifugal-type aspirator to remove “aspirator bran.” The aspirator bran may contain some or all of the germ fraction.

The milling of oil seed also produces a significant amount of bran material as a by-product. Bran materials derived form oil seeds can also be stabilized by the method useful in stabilizing the bran/germ fraction derived from cereal grains. The stabilized oil seed bran is also suitable starting material to prepare emulsified bran derivatives.

The bran/germ fraction derived from cereal grains has a high lipid content and significant lipolytic and oxidative enzyme activities. The milling process releases these enzymes, which can hydrolyze/oxidize the lipids associated with bran and germ fractions leading to rancidity. Several methods have been developed to stabilize the germ and bran components of cereal grains, including application of direct heat (dry or wet heat) and mechanical extrusion. The mechanical extrusion process used for stabilizing bran/germ fraction may further involve addition of moisture to facilitate uniform heating of the bran/germ fraction. Stabilization by mechanical extrusion process utilizes shear, friction, and pressure to generate the heat required to inactivate the lipolytic/oxidative enzymes.

Lipolytic enzymes associated with bran/germ fraction can also be inactivated using chemicals, such as hydrochloric acid, acetic acid, acrylonitrile, and proponal. Bran/germ fraction can also be stabilized by extracting the oil present in the bran material with organic solvents. The organic solvents suitable for this purpose include, but are not limited to, lower alcohols, such as ethanol, butanol, diethyl ethers, ethyl acetate, hexane and the like.

The efficiency of stabilization of bran/germ fraction by any one of these methods can be assessed by measuring the activities of the lipolytic and oxidative enzymes, such as lipase and peroxidases, before and after stabilization process. One of the immediate effects of activation of lipolytic enzymes during the milling process is to release the fatty acids associated with the lipid component of the bran/germ fraction. Without a stabilization process, there is a steady increase in the accumulation of free fatty acid content of the bran/germ fraction. Preferably, the total fatty acid content in the stabilized bran/germ fraction should be less than 5% of the total extractable lipid content of the bran/germ fraction.

Bran material stabilized by mechanical extrusion contains the same level of fat as in raw bran material and is referred to as full-fat stabilized bran material. Bran material stabilized by mechanical extrusion can subsequently be extracted with organic solvents to produce stabilized-defatted bran material. Full-fat stabilized rice bran has a fat content of about 20% by weight, while reduced fat and defatted rice bran has about 4-15% and less than 1-3% fat content, respectively, on weight basis (w/w). Bran derivatives suitable for use in the present invention may include a stabilized bran with full-fat content, a defatted bran material or a stabilized bran with reduced fat content.

Alternatively, bran material with an intermediate-oil-content is obtained by using a pressing process to extract oil rather than solvent extraction. In the pressing process, oil is removed from the stabilized bran utilizing pressure and heat, but no solvent extraction is carried out. This bran feedstock contains approximately one-half the original bran oil content and is referred as reduced-fat bran.

Using stabilized rice bran (SRB) as a starting material, two different bran fractions, namely, a stabilized rice bran soluble fraction, and a stabilized rice bran insoluble fraction, are obtained. These two fractions show enrichment of certain components when compared to the composition of the SRB used as a starting material (Table 1).

TABLE 1
Composition of stabilized rice bran (SRB), and soluble and
insoluble fractions derived from enzymatic treatment of SRB.

| Constituent | | | |
|---|---|---|---|
| (%) | SRB | Soluble | Insoluble |
| Protein | 14.50 | 7.50 | 20.50 |
| Fat | 20.50 | 26.50 | 13.50 |
| Total | 51.00 | 57.50 | 52.50 |
| Carbohydrate | | | |
| Dietary Fiber | 29.00 | 3.00 | 42.00 |
| Soluble Fiber | 2.00 | 3.00 | 0.80 |
| E-vitamins | 25.60 | 18.00 | 3.00 |
| B-vitamins | 57.03 | 92.29 | 36.39 |
| Phytosterols | 341.15 | 413.16 | 317.21 |

Referring to Table 1, distribution of the primary components in the fractions changes as a result of the fractionation procedure. For example, the protein component has concentrated in the insoluble fraction, while the soluble fraction has become enriched with the fat component. Dietary fiber has concentrated in the insoluble fraction while B and E vitamins have concentrated in the soluble fraction. Redistribution of the major components into the soluble and insoluble fractions, respectively, imparts distinct functionality relative to the original material.

Use of a defatted bran as a starting material in the present invention produces a different set of end-products including a defatted bran derivative, a defatted insoluble fraction and a defatted soluble fraction.

The soluble bran fraction obtained from SRB contains a significant quantity of the oil. This soluble bran fraction also contains oil-soluble vitamins and phytosterols. In addition to its high oil content, this emulsified soluble bran fraction is enriched in water soluble/hydratable complex carbohydrates, water-soluble vitamins, anti-oxidants and phytosterols.

The soluble bran fraction from SRB includes nutrients that may be beneficial in the human diet and contribute to overall health. However, the relatively high oil content may be disadvantageous due to the added caloric content. Therefore, the oil component may be beneficially reduced by starting the fractionation process with a defatted rice bran. The resulting defatted rice bran fractions would still contain the beneficial carbohydrates, vitamins, antioxidants and phytosterols, but with much reduced oil content and thereby, reduced caloric content. Thus, the emulsified defatted soluble rice bran fraction may find application in special diets, such as for diabetics, providing nutritionally valuable components.

Additionally, the fiber content of the defatted insoluble rice bran fraction is enriched in dietary fiber compared to insoluble full-fat rice bran fraction. The insoluble defatted rice bran fraction may be utilized in various food and beverage applications in which it is desired to increase the dietary fiber content without increasing the caloric load of the product. It is known that the consensus opinion among health professionals is that increasing fiber consumption while decreasing calories is important to maintaining overall long-term health.

Because the soluble bran fraction derived from full-fat bran material is rich in oil, it is difficult to reconstitute the powdered form of soluble bran fraction in an aqueous solution in the preparation of nutritionally enriched beverages. In order to enhance the compatibility of the oil component with an aqueous environment, emulsifiers may be used. Emulsifiers, which are molecules having one lipophilic end and one hydrophilic end, act as an interface between these conflicting components, namely oil in the soluble bran fraction, and the aqueous environment of a desired beverage. Thus, an emulsifier can be used to stabilize a oil-in-water emulsion, in that the oil particles are surrounded by the emulsifier molecule.

A variety of emulsifiers are suitable for use in the present invention. Suitable emulsifiers may be selected from monoglycerides, diglycerides, glycerol monostearates, sorbital monosstearates, esters of carbocyclic acids with mono- and di-glycerides, monosodium phosphate derivatives of mono- and di-glycerides, lecithin, diacetyl tartaric acid esters of mono-diglycerides (data esters), sorbitan esters, diacetyl tartaric acids esters of mono- and di-glycerides, succinylated mono- and di-glycerides acetylated mono- and di-glycerides, hydroxylated lecithin, propylene glycol mono- and di-esters of fatty acids, polyglycerol esters of fatty acids, lactylic esters of fatty acids, and mixtures thereof.

Emulsifiers may be derived from the natural products or chemically synthesized. Common emulsifiers are lecithins, mono- and di-glycerides of fatty acids. The most frequently used raw materials for emulsifiers include palm oil, rapeseed oil, soy bean oil, sunflower oil, or lard/tallow. Basic emulsifier production involves combining oil (triglycerides) with glycerol that result in monoglycerides. The type of triglycerides used determines the type of emulsifier obtained. Unsaturated triglycerides yield fluid emulsifiers such as oil, while the saturated triglycerides results in pasty or solid products. Lecithin is the preferred emulsifier for the present invention.

Lecithin is obtained from soy bean either chemically or by mechanical means. Phosphatidyl choline is a major component in soy bean lecithin. Lecithin can also be obtained from other sources including egg, rice, sunflower seeds etc. Phosphatidyl choline is an integral component of the cell membranes and can be totally metabolized. Lecithin is an approved emulsifier for use in food/beverage production.

Preferably, the emulsifier used in the present invention would be composed of liquid lecithin of approximately 62% acetone insolubles (AI) added in a range of 5% to 15% w/w basis. More preferably, a solid form of deoiled lecithin of between 95 and 98% AI is added in a range from 0.25% to 8% on a w/w basis. The phrase “62% acetone insolubles” refers to the fact that upon dissolution of the lecithin in acetone, 62% of the phospholipid portion of lecithin remains insoluble. Residual impurities such as oil, moisture and soluble non-phospholipids account for 38% of the materials dissolved and extracted by the acetone.

The first step in the process for obtaining an emulsified bran derivative and emulsified bran fractions according to the present invention is to prepare a slurry with preferably, a stabilized rice bran material. The stabilized rice bran or defatted rice bran is used to prepare a 10% to 40% slurry, more preferably a 15% to 30% slurry with potable water in a mixing vessel. A suitable emulsifier in liquid or solid form, in a final concentration in the range of 0.25% to 15% on a w/w emulsifier to bran basis is added to the slurry. In the next step, the slurry is treated with a suitable amount of an enzyme, which may be, but is not limited to, an amylase, a dextrinase, a pentosanase, a hemicellulase or any of a variety of carbohydrases or carbohydrase combinations as well as protein-hydrolyzing enzymes either separately or in combination. The slurry may be heated to a temperature of about 45° C. to 90° C., preferably from 60° C. to 80° C. using, for example a steam injected cooking vessel with an internal mixer or other suitable apparatus. The enzymes hydrolyze the carbohydrates in the stabilized rice bran/defatted rice bran to lower molecular weight dextrins, oligosaccharides and sugars, while the proteases form lower molecular weight proteins, peptides and amino acids. After a suitable period of time, the slurry is transferred to a dryer and dried to produce a powdered product. The resulting powdered product is referred as an emulsified bran derivative. This emulsified bran derivative contains all the components that were originally present in the starting bran material except for the breakdown products resulting from the enzymatic digestion.

In another embodiment of the present invention, the emulsified bran slurry after enzymatic digestion is transferred to a centrifuge in which the insoluble bran fraction is separated from the soluble bran fraction by centrifugal force. The emulsified soluble bran fraction and the emulsified insoluble bran fraction are further treated to remove excess water by a drying process and then ground to produce powdered emulsified soluble bran fraction and a powdered emulsified insoluble bran fraction.

Thus, the process of the present invention may yield three different emulsified bran products namely, an emulsified bran derivative, an emulsified soluble bran fraction, and an emulsified insoluble bran fraction. The emulsified soluble bran fraction and the emulsified insoluble bran fraction are obtained from the fractionation of emulsified bran derivative through a centrifugation process, as described.

The process for fractionating bran material into soluble and insoluble fractions is applicable to a wide variety of bran from different sources, including rice, wheat, oat, barley and other cereal and oil seed brans. The three different emulsified bran products obtained through the process of the present invention are suitable in the preparation of a variety of food products. For example, the emulsified insoluble bran fraction enriched in fiber content is useful in the preparation of fiber rich food products. Similarly, the emulsified bran derivative and the emulsified soluble bran fraction enriched in oil content are suitable in the preparation of food products rich in oil.

Addition of the emulsifiers to the slurry before the initiation of the enzymatic digestion, infuses the soluble bran fractions derived from either stabilized bran or defatted bran with the emulsifier. When the starting bran material is stabilized bran, the powdered soluble bran fraction will have an oil content of approximately 25%. In the absence of an emulsifier, the relatively high oil content of soluble bran fraction contributes to increased resistance of this fraction to hydration, thus requiring additional time and energy to disperse the powdered soluble bran fraction derived from the full-fat stabilized bran material in a liquid. As described in the present invention, addition of the emulsifier reduces the surface tension attributable to the oil and results in a faster dispersal of the dried water-soluble fraction in the aqueous medium.

When a defatted bran material is used as a starting material in the present process, the oil content of the resulting powdered soluble bran fraction will be significantly reduced to a level of about 2-3%, thereby reducing the surface tension of the powdered soluble bran fraction. However, hydration of the powdered water soluble fraction derived from the enzymatic digestion of the defatted bran may still be hindered due to the surface wetting required to easily disperse the powdered material. Again, addition of an emulsifier will aid in increasing the surface hydration rate and the dispersion of the powdered soluble bran fraction derived from the enzymatic digestion of defatted bran material.

Thus, it has been found that the addition of an emulsifier to the stabilized bran or defatted bran material under the described conditions results in greatly increased solubility or dispersibility of the powdered soluble bran fraction allowing for the more efficacious use of this nutrient dense fractions in a variety of food and beverage applications.

In another embodiment of the present invention, the emulsified bran derivative, as well as, the emulsified soluble bran fraction may be used to produce a nutritionally-enriched beverage. The beverage product may be prepared by any known process using known diluents, such as water. The diluents may optionally be-carbonated and/or contain other ingredients, for example citric or other acids, sucrose, artificial sweeteners, coloring agents, flavoring materials, etc. The beverage may comprise juice and fruit flavored drinks with up to 100% fruit juice, coffees and teas, frozen drink forms and even alcohol containing drinks.

In yet another embodiment of the present invention, the emulsified bran derivatives and fractions are suitable for use as processing aid in the preparation of extruded food products. In certain known food preparations, flour is typically mixed with water to produce a dough, which is extruded to produce products of certain shape and size. The extruded product is dried, baked or fried into a final product. Monoglycerides or mixtures of monoglycerides and diglycerides are typically added to starch-containing dough to improve the workability of dough through the extruder. The emulsified bran derivative, as well as, the emulsified soluble bran fraction of the present invention are likewise useful as a processing aid in the extruder providing a more cost-effective processing aid in place of monoglycerides, at the concentration of 0.1% to 5.0% by weight.

The characteristics described for rice bran soluble derivatives are similar to those of other cereal and oil seed derived brans. It should be noted that the application of emulsifiers to the described rice bran derivatives and fractions is equally applicable to those derivatives and fractions produced by the same process using wheat, oat, barley and other cereal and oil seed brans. Thus while rice bran will be used as the exemplary description of the invention, the described process may be applied to any other cereal and oil seed brans.

The forgoing discloses and describes only exemplary embodiments of the present invention for purposes of illustration, not for limiting the scope of the present invention. It is obvious to those skilled in the art that various modifications and variations can be made without departing from the scope and spirit of the present invention.

### EXAMPLE 1

### Preparation and Testing of Dispersibility of Emulsified Bran Fractions

Stabilized rice bran was obtained from raw rice bran following the protocol described in the commonly-owned co-pending U.S. utility patent application Ser. No. 12/316,312 and in PCT patent application number PCT/US2008/013597. Stabilized rice bran was extracted thoroughly with hexane in a Soxhlet extractor to remove the fat completely and the resulting defatted rice bran was dried under air. Both the stabilized rice bran and stabilized-defatted rice bran were subjected to enzymatic digestion either in the presence or absence of an emulsifier. Two different types of lecithin emulsifiers namely, the liquid lecithin and the lecithin powder were used.

In the present example, 250 grams of stabilized or stabilized-defatted bran material was mixed with 2.5 L of boiling hot water. To the resulting slurry, 25 grams of the liquid soy lecithin was added. The liquid lecithin used in this experiment had a acetone insoluble value of 60. Thus, the liquid lecithin used in the experiment had a fat content of about 40%. In an alternative example, the stabilized bran and the stabilized-defatted bran were emulsified by adding 5 grams of powdered lecithin to a slurry prepared by mixing 250 grams of bran material in 2.5 L of boiling hot water. The powdered lecithin had a acetone soluble value of 97% and a fat content of 2-3%.

The enzymatic digestion of emulsified bran material was initiated with the addition of 1.5 ml of alpha-amylase (Genencor International). The enzyme addition was done with stirring. The slurry was stirred and heated at about 90° C. for one hour by steam injection and cooled to 50-55° C. The slurry was then pumped to a horizontal centrifuge wherein the insoluble fraction was separated. The insoluble fraction was collected and then dried in a drum dryer, and subsequently ground into a powder. The powder represented the emulsified stabilized rice bran insoluble fraction. The aqueous material was pumped to a drum dryer and then dried. This dried aqueous portion produced the emulsified stabilized rice bran soluble fraction. Thus in this experiment, the following rice bran fractions were prepared: (1) Stabilized rice bran insoluble fraction (control), (2) Stabilized rice bran soluble fraction (control), (3) Emulsified, stabilized rice bran insoluble fraction, (4) Emulsified, stabilized rice bran soluble fraction, (5) Stabilized-defatted rice bran insoluble fraction (control), (6) Stabilized-defatted rice bran soluble fraction (control), (7) Emulsified, stabilized-defatted rice bran insoluble fraction, and (8) Emulsified, stabilized-defatted rice bran soluble fraction.

All of the emulsified soluble bran fractions as well as the control soluble bran fraction without emulsifier, were tested for their dispersibility in water by means of adding 1 gram of the powdered material to 50 ml of water in a beaker. When added to water, the control product sat on the water surface. The emulsified material dispersed into water with little or no mechanical agitation. With mechanical agitation, the control material can be made to disperse if sufficient energy is applied, whereas the lecithinated material immediately dispersed with minimal energy input. This easy dispersibility in an aqueous solution makes the emulsified material a suitable candidate for manufacturing nutritionally-enriched beverages.

What is claimed is:

1. A process for making an emulsified bran derivative, the process comprising the steps of:
providing a bran material;
providing an emulsifier in an aqueous environment to prepare a slurry;
adding one or more enzymes to the resulting slurry; and,
drying-the-enzyme-treated slurry to produce a powdered, emulsified, enzyme treated bran derivative.

2. The process of claim 1, wherein the bran material and emulsifier in the aqueous environment forms about a 10% to 40% solid bran slurry.

3. The process of claim 1, further comprising heating the aqueous slurry after the enzyme is added.

4. The process of claim 3, wherein the aqueous slurry is heated to about 45° C. to about 90° C.

5. The process of claim 1, wherein the enzyme is selected from the group consisting of a dextranase, a maltase, an α-amylase, pentosanase, a hemicellulase, and a protein-hydrolyzing enzyme.

6. The process of claim 1, wherein the emulsifier is present at about 0.25% to 15% of the slurry on a emulsifier to bran w/w basis.

7. The process of claim 1, wherein the emulsifier is lecithin.

8. The process of claim 1, wherein the emulsifier is liquid lecithin with approximately 62% acetone insolubles.

9. The process of claim 1, wherein the emulsifier is powdered lecithin.

10. The process of claim 1, wherein the emulsifier is powdered lecithin with approximately 97% acetone insolubles.

11. The process of claim 1, wherein the bran material is stabilized rice bran.

12. The process of claim 1, wherein the bran material is defatted rice bran.

13. The process of claim 1, further comprising the steps of:
separating the enzyme treated slurry by centrifugation into a soluble fraction and an insoluble fraction; and,
drying the soluble and the insoluble fractions separately to produce two different powdered emulsified nutritionally enhanced bran derivatives.

14. A process for making emulsified bran fractions, the process comprising the steps of:
providing a bran material;
providing an emulsifier in an aqueous environment to prepare a slurry;
adding one or more enzymes to the resulting slurry;
separating the enzyme treated slurry into a soluble fraction and an insoluble fraction; and,
drying the soluble and the insoluble fractions separately to produce two different powdered emulsified nutritionally enhanced bran fractions.

15. The process of claim 14, wherein the bran material is stabilized rice bran.

16. The process of claim 14, wherein the emulsifier is lecithin.

17. The process of claim 14, wherein the separation of the enzyme treated slurry into a soluble fraction and an insoluble fraction is by centrifugation.

18. A food product comprising an emulsified bran material selected from the group consisting of an emulsified bran derivative, an emulsified soluble bran fraction, and an emulsified insoluble bran fraction.

19. The food product of claim 18, wherein the emulsified bran material is an emulsified rice bran derivative.

20. The food product of claim 18, wherein the emulsified bran material is an emulsified soluble rice bran fraction.

21. The food product of claim 18, wherein the emulsified bran material is an emulsified insoluble rice bran fraction.

22. A beverage comprising an emulsified bran material selected from the group consisting of an emulsified bran derivative, an emulsified soluble bran fraction, and an emulsified insoluble bran fraction.

23. A method of improving machinability of a workable dough, the method comprising adding an emulsified rice bran material to an extruder, the emulsified bran material having been prepared by treating rice bran with enzymes in the presence of an emulsifier.

24. The method of claim 23, where in the emulsified bran material is selected from the group consisting of emulsified rice bran derivative, emulsified soluble rice bran fraction and emulsified insoluble rice bran fraction.
